(19) United States
(12) Patent Application Publication
(10) Pub. No.: US 2020/0100981 A1
(43) Pub. Date: Apr. 2, 2020

(54) PERCUSSION THERAPY APPARATUS HAVING ECCENTRIC MOTORS

(71) Applicant: Hill-Rom Services, Inc., Batesville, IN (US)

(72) Inventors: John A. Bobey, Batesville, IN (US); Brian E. Byrd, Batesville, IN (US)

(21) Appl. No.: 16/553,541

(22) Filed: Aug. 28, 2019

Related U.S. Application Data
(60) Provisional application No. 62/737,964, filed on Sep. 28, 2018.

(51) Int. Cl. A61H 7/00; A61H 23/00; A61H 23/02

(52) U.S. Cl. CPC A61H 7/004; A61H 23/006; A61H 2205/084; A61H 2201/165; A61H 2201/1671; A61H 23/0218

(57) ABSTRACT

A percussion therapy apparatus for providing percussion therapy to a patient's body includes a torso covering for securing to a patient's torso. The torso covering includes a front panel having an interior side for engaging the patient's chest and a rear panel having an interior side for engaging the patient's back. A plurality of percussive devices are coupled to the torso covering to provide percussive force to the patient's torso. The percussive devices include an eccentric mass that rotates about an axis.

### CROSS-REFERENCE TO RELATED APPLICATIONS

This application claims priority under 35 U.S.C. § 119(e) to U.S. Provisional Patent Application Ser. No. 62/737,964, filed Sep. 28, 2018, which is expressly incorporated by reference herein.

### TECHNICAL FIELD

The present disclosure relates to devices, systems, and methods for percussion therapy. More specifically, the present disclosure relates to devices, systems, and methods for percussion therapy for a patient's torso.

### BACKGROUND

Patient respiratory systems can experience build-up of phlegm, mucous, and similar substances. Typically, healthy patients can expectorate such build-ups naturally. Certain respiratory ailments and other conditions affecting respiratory function can create excessive build-up and/or make expectoration more difficult. Chronic sufferers of excessive build-up and/or reduced expectoration ability, such as, for example, those with cystic fibrosis, may require assistance to remove such build-up.

Percussive therapy can assist in dislodging mucous and other build up from respiratory systems. However, proper manual percussive therapy generally requires a trained practitioner to perform the therapy on the patient. Moreover, manual percussive therapy can be time consuming and physically demanding for the practitioner, as well as uncomfortable and ineffective for the patient-recipient.

### SUMMARY

The present disclosure includes one or more of the features recited in the appended claims and/or the following features which, alone or in any combination, may comprise patentable subject matter.

According to one aspect of the disclosed embodiments, a percussion therapy apparatus for providing percussion therapy to a patient's body may include a torso covering for securing to a patient's torso. The torso covering may include a front panel having an interior side for engaging the patient's chest and a rear panel having an interior side for engaging the patient's back. A plurality of percussive devices may be coupled to the torso covering to provide percussive force to the patient's torso. The percussive devices may each include an eccentric mass that rotates about an axis, which is generally parallel with an underlying portion of the patient's torso.

In some embodiments, a motor may be provided to rotate the eccentric mass about the axis. The eccentric mass may include a center of gravity. A rod may extend from the motor and couple to the eccentric mass at a position off the center of gravity of the eccentric mass. The eccentric mass may rotate to a disengaged position when the motor is turned off.

Alternatively or in addition, a magnet may be coupled to the rod. A sensor may be configured to detect a magnetic field from the magnet to determine a rotational position of the eccentric mass.

Optionally, a first plurality of percussive devices may be provided on the front panel of the torso covering. The eccentric masses of the first plurality of percussive devices may be synchronized to be simultaneously in the same angular orientation relative to the axis. A second plurality of percussive devices may be provided on the rear panel of the torso covering. The eccentric masses of the second plurality of percussive devices may be synchronized to be simultaneously in the same angular orientation relative to the axis.

It may be contemplated that the torso covering includes a vest. The torso covering may include a wrap.

It may be desired that a user interface is releasably coupled to the torso covering and in communication with the plurality of percussive devices and configured to receive user input for adjusting percussive force of the plurality of percussive devices. The user interface may be releasably coupled to the front panel.

In some embodiments, the front panel of the torso covering may include a first section and a second section coupled to each other at a medial intersection. The first and second sections may be releasably coupled at the medial intersection by a zipper assembly having first and second zipper portions attached to the first and second sections, respectively. The first and second zipper portions may each have a top end and bottom end and are each angled between its respective top and bottom ends within the range of about 1 to about 5 degrees from the sagittal plane in opposite lateral directions.

Optionally, a power source may be releasably coupled to the torso covering. A break button may be provided for pausing a percussion cycle of the plurality of percussive devices. A power port may be coupled to the torso covering.

It may be desired that at least one of the front panel and the rear panel includes an inner pane, an outer pane, and a frame pane disposed between the inner and outer panes. The inner and outer pane may include compression foam and the frame pane may include a semi-rigid plastic.

According to another aspect of the disclosed embodiments, a percussion therapy apparatus for providing percussion therapy to a patient's body may include a torso covering for securing to a patient's torso. The torso covering may include a front panel having an interior side for engaging the patient's chest and a rear panel having an interior side for engaging the patient's back. A first plurality of percussive devices may be coupled to the front panel. A second plurality of percussive devices may be coupled to the rear panel. The first plurality of percussive devices and the second plurality of percussive devices may each include an eccentric mass that rotates to provide percussive force to the patient's torso. The eccentric masses of the first plurality of percussive devices and the second plurality of percussive devices may be synchronized to be at substantially equivalent angular orientations about an axis when viewed in a clockwise orientation.

It may be contemplated that a plurality of motors rotates each eccentric mass about the respective axis. Each eccentric mass may include a center of gravity. A rod may extend from the respective motor and couple to the eccentric mass at a position off the center of gravity of the eccentric mass. Each eccentric mass may rotate to a disengaged position when the motor is turned off.

Alternatively or in addition, a magnet may be coupled to each rod. A plurality of sensors may be configured to detect a magnetic field from a respective magnet to determine a rotational position of the respective eccentric mass.

In some embodiments the torso covering may include a vest. The torso covering may include a wrap.

It may be desired that a user interface is releasably coupled to the torso covering and in communication with the first and second plurality of percussive devices and configured to receive user input for adjusting percussive force of the first and second plurality of percussive devices. The user interface may be releasably coupled to the front panel.

Optionally, the front panel of the torso covering may include a first section and a second section coupled to each other at a medial intersection. The first and second sections may be releasably coupled at the medial intersection by a zipper assembly having first and second zipper portions attached to the first and second sections, respectively. The first and second zipper portions may each have a top end and bottom end and may each be angled between its respective top and bottom ends within the range of about 1 to about 5 degrees from the sagittal plane in opposite lateral directions.

In some embodiments, a power source may be releasably coupled to the torso covering. A break button may be provided for pausing a percussion cycle of the first and second plurality of percussive devices. A power port may be coupled to the torso covering.

Optionally, at least one of the front panel and the rear panel may include an inner pane, an outer pane, and a frame pane disposed between the inner and outer panes. The inner and outer pane may include compression foam and the frame pane may include a semi-rigid plastic.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a front elevation view of a percussion therapy apparatus for providing percussion therapy to a patient's body;

FIG. 2 is a rear elevation view of the percussion therapy apparatus shown in FIG. 1;

FIG. 3 is a cross-sectional view of the percussion therapy apparatus taken along line 3-3 in FIG. 1 and showing an eccentric mass in a first position;

FIG. 4 is a cross-sectional view similar to FIG. 3 showing the eccentric mass in a second position;

FIG. 5 is a front elevation view of an embodiment of a circular eccentric mass;

FIG. 6 is a front elevation view of an embodiment of an oblong eccentric mass;

FIG. 7 is a top perspective view of another embodiment of a percussion therapy apparatus;

FIG. 8 is a schematic diagram of a control system of the percussion therapy apparatuses shown in FIGS. 1 and 7; and

FIG. 9 is a flowchart of a method for synchronizing the eccentric masses of the percussion therapy apparatuses shown in FIGS. 1 and 7.

### DETAILED DESCRIPTION

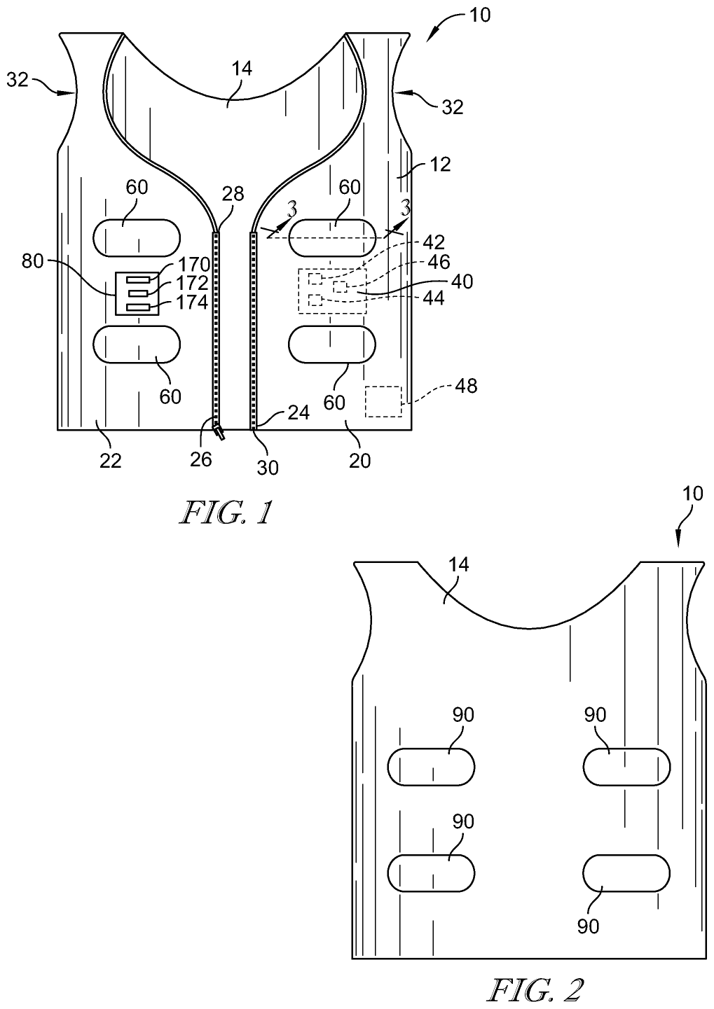

Referring to FIG. 1, a percussion therapy apparatus 10 is illustrated as a vest that is configured to position around a patient's torso. The percussion therapy apparatus 10 includes a plurality of eccentric masses (described in more detail below) that are rotated repeatedly to apply oscillations or vibrations to the patient's torso to loosen the build-up of phlegm, mucous, and similar substances so that the patient can expectorate. The eccentric masses are rotated between a first position in which the eccentric masses are oriented toward the patient's torso and a second position in which the eccentric masses are oriented away from the patient's torso. A speed of the rotation of the eccentric masses may be altered to change the frequency of oscillations to thereby tailor the therapy to the patient's needs.

In some embodiments, all of the eccentric masses are synchronized to be simultaneously in the first position and then 180° later to be simultaneously in the second position. In other embodiments, a first plurality of eccentric masses is synchronized to be simultaneously oriented toward a front of the patient's torso while a second plurality of eccentric masses is synchronized to be simultaneously oriented toward a back of the patient's torso while the first and second plurality of eccentric masses are 180° out of phase with each other. The synchronization scheme depends upon whether the eccentric masses are rotating in clockwise or counter clockwise directions when viewed along the axes of rotation of the eccentric masses from a common vantage point. In any event, the goal of the synchronization of the rotating eccentric masses in some embodiments is to have them all oriented toward the patient substantially simultaneously and all oriented away from the patient substantially simultaneously. In other embodiments, the angular orientations of the eccentric masses about their respective axes may not be in synch, but the rotational speed may be substantially equivalent, so that the peaks and valleys of percussive oscillations are out of phase by some desired amount at different locations of the patient's torso.

The apparatus 10 includes a front panel 12 and a back panel 14 coupled to the front panel 12. The front panel 12 includes a left side 20 and a right side 22 that is configured to couple to the left side 20 at a medial intersection. In the illustrative embodiment, the left side 20 includes a left zipper portion 24, and the right side 22 includes a right zipper portion 26. The left zipper portion 24 is configured to couple to the right zipper portion 26 to secure the apparatus 10 on the patient. The left zipper portion 24 and the right zipper portion 26 include a top end 28 and a bottom end 30. In some embodiments, the top end 28 and the bottom end 30 are angled within a range of about 1 degree to 5 degrees from a sagittal plane in opposite lateral directions. In some embodiments, the front panel 12 includes other fastening mechanisms, for example, buttons, buckles, hook and loop fasteners, straps, straps with buckles, or the like. Arm holes 32 extend between the left side 20 and right side 22 of the front panel 12 and the back panel 14. The arm holes 32 are sized to receive the patient's arms.

A main control pocket 40 is positioned within the front panel 12. In an alternative embodiment, the main control pocket 40 may be positioned within the back panel 14. The main control pocket 40 houses a main control unit 42 having a processor and a memory. A power supply 44 is also positioned within the main control pocket 40 and electrically coupled to the main control unit 42 to power the main control unit 42. The power supply 44 may be a battery. In some embodiments, the battery is replaceable. In other embodiments, the battery is rechargeable. A power port 46 extends from the power supply 44 to an outlet 48 on the apparatus 10. The outlet 48 is configured to receive a power cord to recharge the power supply 44.

The front panel 12 also includes a plurality of pockets 60 to retain an eccentric mass (described in more detail below). Cables (not shown) extend from the pockets 60 to the main control pocket 40 to supply power from the main control unit 42 to the eccentric masses or, more particularly, to motors that rotate the eccentric masses. In the illustrative embodiment, the front panel 12 includes four pockets 60; however, the front panel 12 may include any number of pockets 60. The left side 20 of the front panel 12 includes two pockets, and the right side 22 of the front panel 12 includes two pockets in the illustrative example.

A user interface 80 is detachably coupled to the front panel 12. The user interface 80 includes a plurality of buttons to provide inputs to the main controller, and thereby control the eccentric masses (as described in more detail below). The user interface 80 may be coupled to the front panel 12 with hook and loop fasteners, or the like. The user interface 80 includes a cable (not shown) that couples the user interface 80 to the main control unit 42. In some embodiments, the user interface 80 may be wirelessly coupled to the main control unit 42. The user interface 80 is removable from the front panel 12 to enable the patient and/or a caregiver to handle the user interface 80 to control the apparatus. In some embodiments, the user interface 80 may be a separate component that does not couple to the front panel 12 and communicates wirelessly with the main control unit 42.

Referring to FIG. 2, the back panel 14 includes a plurality of pockets 90 that are each configured to retain a respective eccentric mass. The back panel 14 includes four pockets 90 arranged in rows of two. In other embodiments, the back panel 14 may include any number of pockets 90.

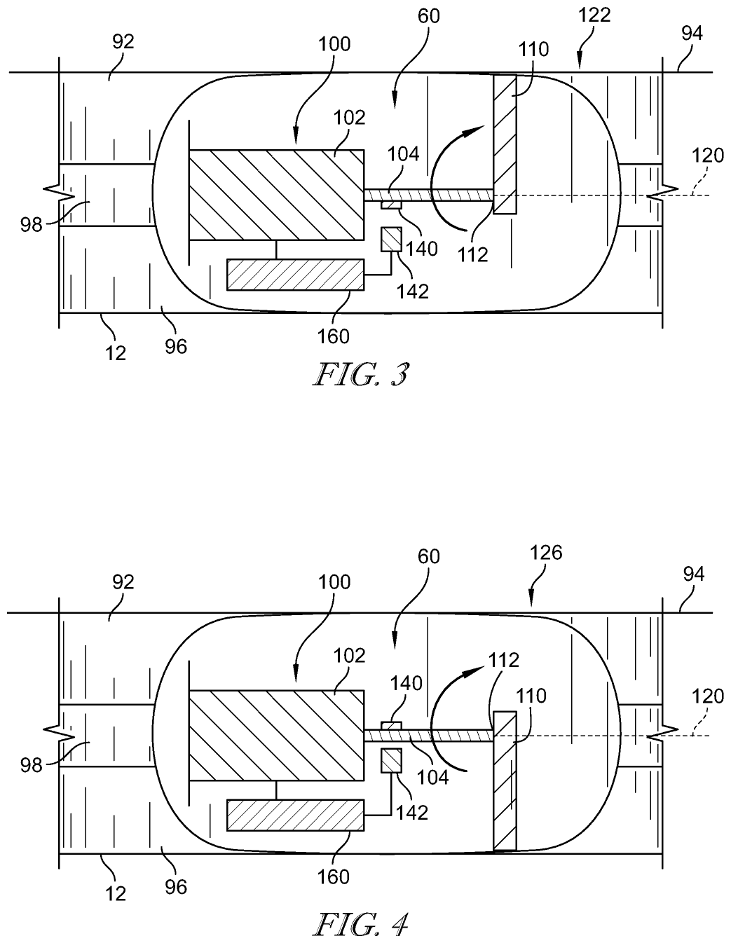

Referring to FIGS. 3 and 4, an eccentric mass assembly 100 is illustrated within a pocket 60. It will be appreciated that an eccentric mass assembly 100 is positioned within each pocket 60 on the front panel 12. It will also be appreciated that an eccentric mass assembly 100 is also positioned within each pocket 90 on the back panel 14. Accordingly, in the illustrative embodiment, the apparatus 10 includes eight eccentric mass assemblies 100, four on the front panel 12 and four on the back panel 14. For the sake of brevity, the eccentric mass assembly 100 is described herein with respect to one of pockets 60 but the same description is equally applicable to the eccentric mass assemblies in the back pockets 90. In some embodiments, the eccentric mass assembly 100 may be removable from the pocket 60 so that the apparatus 10 is operable with fewer assemblies 100. Embodiments in which some of eccentric mass assemblies 100 are disabled, or turned off, during operation of other eccentric mass assemblies 100 are also contemplated by this disclosure.

The front panel 12 includes an inner pane 92 that positions against the patient's torso 94 and an outer pane 96 that positions away from the patient's torso 94. In some embodiments, the inner pane 92 and the outer pane 96 are formed from compression foam. In other embodiments, the inner pane 92 and the outer pane 96 are formed from any material suitable to provide comfort to the patient, for example, cotton filling, gel, or the like. A frame pane 98 extends between the inner pane 92 and the outer pane 96. The frame pane 98 may be formed from a semi-rigid plastic. The pocket 60 is illustrated as being positioned within the inner pane 92, the outer pane 96, and the frame pane 98. In other embodiments, the pocket 60 is only formed within the frame pane 98, and the inner pane 92 and the outer pane 96 extend across the pocket 60. In still other embodiments, pocket 60 is formed within the inner pane 92 and frame pane 98 but not the outer pane 96, or within outer pane 96 and frame pane 92 but not inner pane 92.

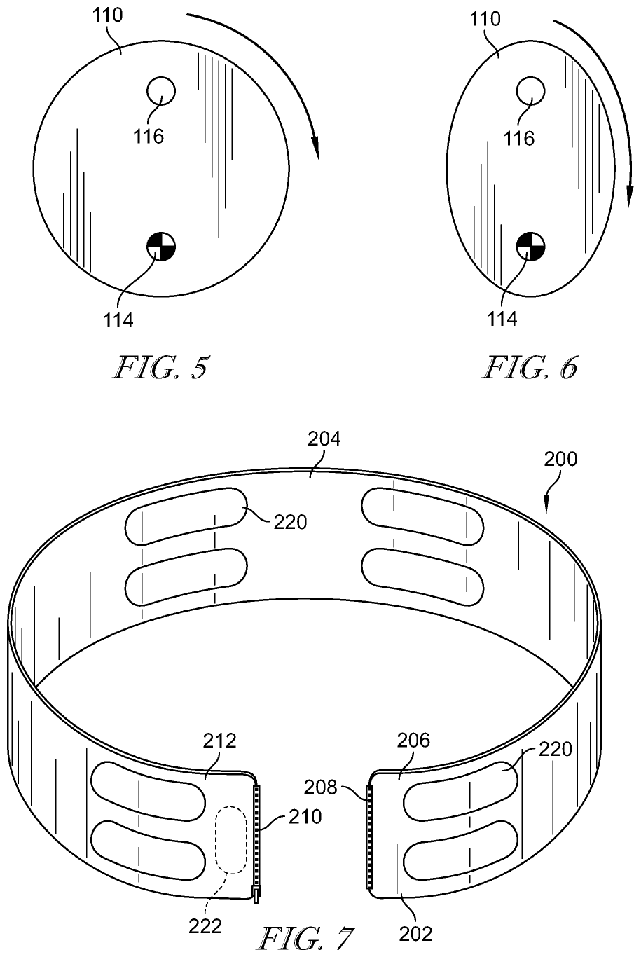

The eccentric mass assembly 100 includes a motor 102 and an output shaft of rod 104 extending from the motor 102. The rod 104 is generally parallel with a portion of the patient's torso 94 and extends along a longitudinal axis 120. An eccentric mass 110 is coupled to an end 112 of the rod 104 opposite the motor 102. As illustrated in FIG. 5, the eccentric mass 110 may be circular or, as illustrated in FIG. 6, the eccentric mass 110 may be oblong in shape. It will be appreciated that the eccentric mass 110 may have other shapes. Referring to FIGS. 5 and 6, the eccentric mass 110 includes a center of gravity 114. The rod 104 is coupled to the eccentric mass 110 at a position defined by a hole or aperture 116 that is offset from the center of gravity 114 so that the eccentric mass 110 resembles a cam when attached to rod 104. The angular orientation of eccentric mass 110 is defined as the angular position of the center of gravity 114 about the respective axis 120 as measured from some arbitrary origin axis, such as an axis extending vertically upwardly and perpendicularly from axis 120, assuming axis 120 is oriented horizontally.

The motor 102 is configured to rotate the rod 104 about the longitudinal axis 120 to rotate the eccentric mass 110 between the first position 122, shown in FIG. 3, in which the eccentric mass 110 is oriented toward the patient's torso 94, and a second position 126 in which the eccentric mass 110 is oriented away from the patient's torso 94. As the center of gravity 114 of eccentric mass 110 moves toward the patient's torso 94, a force or pressure is applied against the patient's torso 94 and as the center of gravity 114 of the eccentric mass 110 moves away from the patient's torso 94, the force or pressure is released from the patient's torso 94. Thus, it should be appreciated that the force or pressure induced by the rotating eccentric mass 110 on the patient's torso 94 occurs throughout a range of intermediate positions between the illustrated second position 126 and first position 122 because that is when the center of gravity 114 is moving toward the patient's torso 94. By cyclically rotating the eccentric mass 110 between the first position 122 and the second position 126, oscillatory pressure is applied to the patient's torso 94 to loosen congestion within the patient's lungs.

A magnet 140 is coupled to the rod 104 and rotates with the rod 104 in the illustrative example. The magnet 140 is aligned with a sensor 142, for example, a Hall effect sensor, that determines a position of the magnet 140 based on a strength of the magnetic field generated by the magnet 140. For example, in FIG. 3, the magnet 140 is rotated to a position adjacent the sensor 142, thereby generating a magnetic field that indicates that the eccentric mass 110 is in the first position 122. In FIG. 4, the magnet 140 is rotated to a position away from the sensor 142, thereby generating a smaller magnetic field that indicates that the eccentric mass 110 is in the second position 126. In some embodiments, the assembly 100 includes an optical encoder in lieu of the magnet 140 and Hall effect sensor 126. Assembly 100 optionally includes a mechanical means of starting and stopping the rotating eccentric mass 110 in a known position by means of a magnet, detent or other way to capture the eccentric mass 110 when not in motion. Thus, the mechanical means operates to place the eccentric masses 110 in a home position when the respective assemblies 110 are turned off, for example.

A controller 160 is electrically coupled to the motor 102 and the sensor 142. The controller 160 is also coupled to the main control unit 42. In some embodiments, the eccentric mass assembly 100 does not include an individual controller 160 and the eccentric mass assembly 100 is controlled directly by the main control unit 42. The controller 160 is configured to control a rotational speed of the motor 102 to control a percussion cycle of the eccentric mass 110. The controller 160 also receives feedback from the sensor 142 to indicate a position of the eccentric mass 110 to the controller 160. By monitoring the position of the eccentric mass 110, the rotational speed of the motor 102 can be increased or decreased by the controller 160 to maintain the percussion cycle of the eccentric mass 110 if the eccentric mass 110 is off cycle or not properly synchronized with other eccentric masses 110 in the desired manner.

Referring back to the user interface 80 shown in FIG. 1, the user interface 80 is operable to control the eccentric mass 110 by sending signals to the controller 160. The user interface 80 includes user inputs 170 that enable the patient to turn the apparatus 10 on and off. Additionally, a break button 172 is provided to pause the percussive cycle of the eccentric masses 110. In some embodiment, the user interface 80 includes two break buttons, wherein a first break button pauses the eccentric masses 110 in the back panel 14, and a second break button pauses the eccentric masses 110 in the front panel 12. Other user inputs 174 are provided for controlling the rotational speed of the eccentric masses 110 thereby to control the frequency of the chest wall oscillation therapy.

During operation, the eccentric masses 110 are configured to be synchronized as discussed above. In some embodiments, the eccentric masses 110 are controlled to be simultaneously at substantially equivalent angular orientations about the longitudinal axis 120 when viewed in a clockwise orientation. The eccentric masses 110 are configured to be simultaneously in the first position 122 oriented toward the patient's torso 94, and to be simultaneously in the second position 126 oriented away from the patient's torso 94 by having all of the eccentric masses 110 on the same percussion cycle. Thus, in some embodiments, all of the eccentric masses 110 in the front panel 12 and the eccentric masses 110 in the back panel 14 are synchronized. In another embodiment, the eccentric masses 110 in the front panel 12 may be synchronized to be in one angular position, while the eccentric masses 110 in the back panel 14 are synchronized to be in another angular position. For example, all of the eccentric masses 110 in the front panel 12 may be synchronized to be in the first position 122, while all of the eccentric masses 110 in the back panel 14 are synchronized to be in the second position 126, and vice versa. In such an alternative embodiment, the percussive oscillations applied to the front of the patient's torso are 180° out of phase with the percussive oscillations applied to the page of the patient's torso.

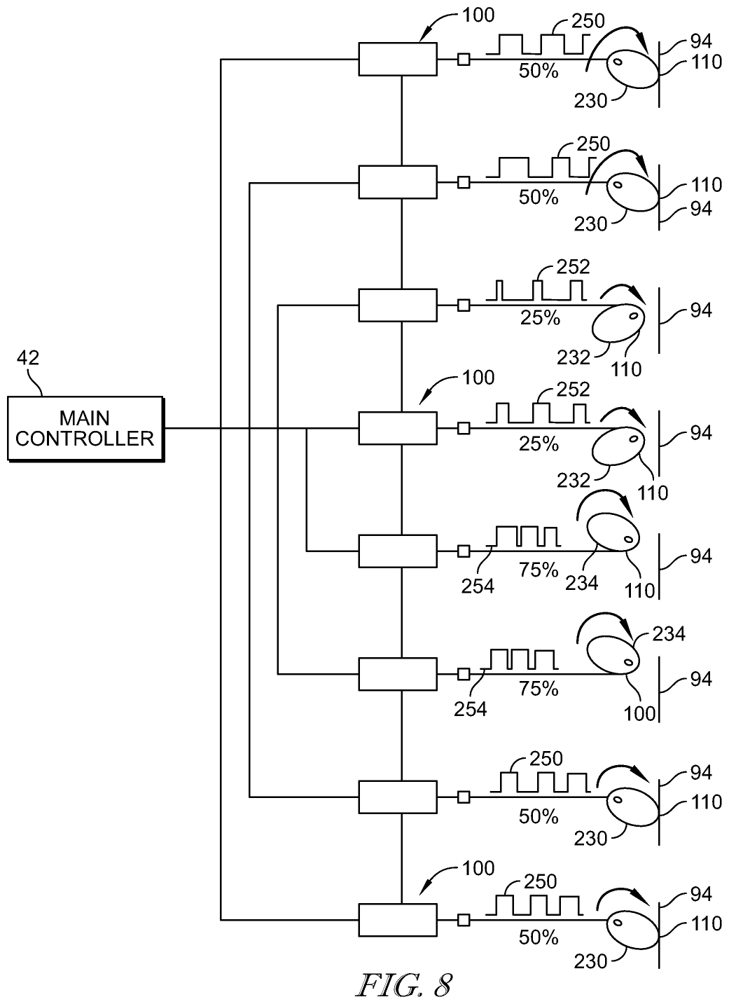

If a controller 160 or the main control unit 42 detects that one of the eccentric masses 110 is off the desired percussion cycle (e.g., not properly synchronized), the controller 160 or control unit 42, as the case may be, sends a signal to the respective motor 102 to increase or decrease a speed of the eccentric mass 110 to bring the eccentric mass 110 back in synch with the percussion cycle as will be described in further detail below in connection with FIG. 8. In some embodiments, when the apparatus 10 is turned off or when the break button 172 is activated, the eccentric masses 110 that are deactivated rotate to the second position 126 oriented away from the patient's torso 94. For example, the controller 160 may send a signal to the motor 102 to rotate the eccentric mass 110 to the disengaged position 126. Optionally, gravity may pull the eccentric masses 110 into a downwardly oriented position when the eccentric masses 110 are deactivated.

Referring to FIG. 7, another embodiment of a percussion therapy apparatus 200 is illustrated as a wrap that is configured to position around a patient's torso 94. The apparatus 200 includes a front panel 202 coupled to a back panel 204. The front panel 202 includes a left side 206 having a zipper portion 208 that is configured to couple to a zipper portion 210 on a right side 212. In other embodiments, other fasteners as described above may be utilized.

The apparatus 200 includes a plurality of pockets 220 configured to retain eccentric mass assemblies 100, as described above. The apparatus 200 includes eight pockets 220, four in the front panel 202 and four in the back panel 204. However, the apparatus 200 may include any number of pockets 220 to retain any number of eccentric mass assemblies 100. The apparatus 200 also includes a main controller pocket 222 configured to retain a main control unit 42, as described above. Additionally, a user interface 80, as described above, is coupled to the front panel 202. It should be appreciated that the eccentric mass assemblies 100 of the apparatus 200 are configured to operate in the same manner as described above with respect to the apparatus 10.

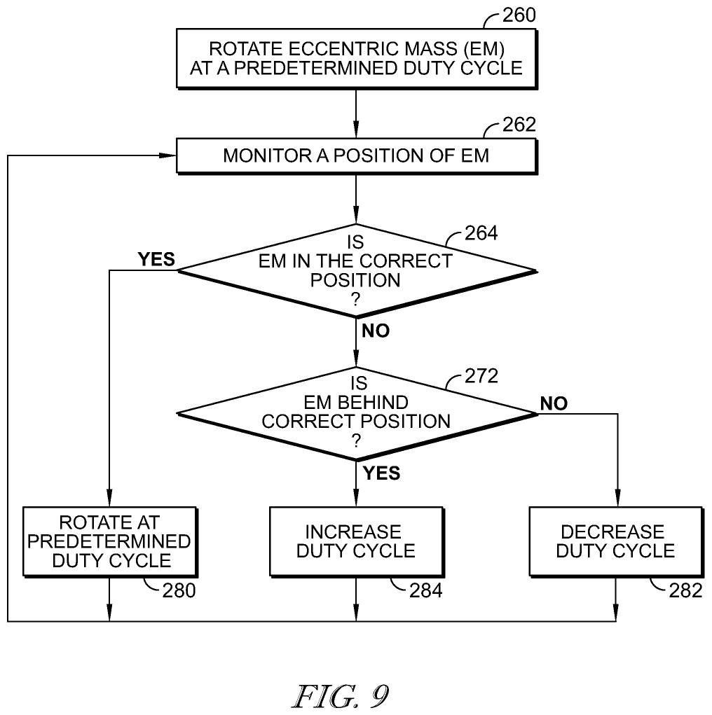

Referring to FIGS. 8 and 9, an example of a method of operation for the apparatus 10 and the apparatus 200 is shown and described. Referring to FIG. 8, the main control unit 42 is coupled to a plurality of eccentric mass assemblies 100. At block 260 of FIG. 9, the eccentric mass assemblies 100 are configured to be rotated in synch pursuant to a predetermined percussion cycle. The predetermined percussion cycle is determined by the patient or a caregiver and selected based on the patient's needs and comfort. The predetermined percussion cycle determines a speed at which the eccentric masses 110 rotate. In the exemplary embodiment, a percussion cycle corresponding to a 50% duty cycle for a pulse width modulated (PWM) voltage signal to be applied to motor 102 of each eccentric mass assembly 100 is selected.

At block 262, the sensors 142 monitor a position of the eccentric masses 110. At block 264, the controller 160 determines whether the eccentric masses 110 are in the correct position. For example, eccentric masses 230 are in synch and positioned at the same angular orientation relative to the patient's torso 94, as illustrated in FIG. 8. Eccentric masses 232 are ahead of or leading the percussion cycle, and eccentric masses 234 are behind or lagging the percussion cycle.

If the eccentric mass 110, for example eccentric masses 230, is in the correct position, the eccentric mass 110 continues to be rotated at the predetermined duty cycle, as shown at block 280 in FIG. 9. As shown in FIG. 8, because eccentric masses 230 are in the correct position, the eccentric masses 230 continue to receive a PWM signal 250 having a 50% duty cycle.

If the eccentric mass 110, for example eccentric masses 232, are not in the correct position, the controller 160 determines whether the eccentric masses 110 are behind the correct position, at block 272 of FIG. 9. If the eccentric mass 110 is not behind the correct position, the eccentric mass 110 is determined by the controller 160 to be ahead of the correct position and is rotated with a lower duty cycle, at block 282, until the eccentric mass 110 is in synch with the predetermined percussion cycle. As shown in FIG. 8, because eccentric masses 232 are ahead, the eccentric masses 232 receive a PWM signal 252 having a 25% duty cycle to slow the eccentric masses 232.

If the eccentric mass 110, for example eccentric masses 234, are determined by the controller 160 to be behind the correct position, as indicated at block 272, the eccentric mass 110 is rotated with a higher duty cycle, as indicated at block 284, until the eccentric mass 110 is in synch with the predetermined percussion cycle. As shown in FIG. 8, because eccentric masses 234 are behind, the eccentric masses 234 receive a signal 254 having a 75% duty cycle to speed up the eccentric masses 234. The 25%, 50%, 75% duty cycles are given as arbitrary examples in this description for the sake of simplicity and that PWM duty cycle adjustments that are slightly above or slightly below the target duty cycle, such as on the order of 1% or 2% above or below the target, may be all that is required to adjust the positions of the eccentric masses 110 back into the proper synchronization.

By maintaining the synchronicity of the eccentric masses 110, the apparatuses 10 and 200 are capable of providing optimum percussive cycles, or at least the desired percussive cycles, on the patient's torso 94 to loosen congestion within the patient's lungs. The apparatuses 10 and 200 synchronize the eccentric masses 110 in a portable garment such that the oscillatory percussive forces are concentrated to the patient's thorax to increase the compression and therefore increase the induced flow in the lungs. The induced flow is a contributor to loosening and transporting mucus in the patient's lungs. The eccentric mass assemblies 100 create a vibratory action by having a spinning motor 102 and an off center rotating eccentric mass 110. The location of the eccentric mass 110 is measured or sensed so that the control signal to the motor can be adjusted to align the vibration such the eccentric masses 110 align in synch and compress the chest wall uniformly. In various embodiments, the locations of the eccentric masses are acquired by one or more of an optical encoder, a hall effect sensor or a mechanical means of starting and stopping the rotating eccentric mass 110 in a known position by means of a magnet, detent or other way to capture the eccentric mass 110 when not in motion. Other apparatuses and methods contemplated herein include the use of stepper motors with optical encoders such that the location of the rotating eccentric masses are always known. Other actuators with location feedback could also be employed in other embodiments.

Compressing the chest wall uniformly reduces the space that the lungs occupy and creates pressure on the lungs which, in turn, constricts the passageways pushing the air out from the small bronchial passages to the major passageways. This is similar to the effect of the patient's diaphragm moving. This method also creates large induced airflow. The method creates mini coughs which dislodges and mobilize the secretions out of the patient's lungs.

Although this disclosure refers to specific embodiments, it will be understood by those skilled in the art that various changes in form and detail may be made without departing from the subject matter set forth in the accompanying claims.

1. A percussion therapy apparatus for providing percussion therapy to a patient's body, the percussion therapy apparatus comprising:
a torso covering for securing to a patient's torso, the torso covering including a front panel having an interior side for engaging the patient's chest and a rear panel having an interior side for engaging the patient's back, and
a plurality of percussive devices coupled to the torso covering to provide percussive force to the patient's torso, the percussive devices each including an eccentric mass that rotates about an axis, which is generally parallel with an underlying portion of the patient's torso.

2. The apparatus of claim 1, further comprising a motor to rotate the eccentric mass about the axis.

3. The apparatus of claim 2, wherein the eccentric mass includes a center of gravity, and wherein a rod extends from the motor and couples to the eccentric mass at a position off the center of gravity of the eccentric mass.

4. The apparatus of claim 3, wherein the eccentric mass rotates to a disengaged position when the motor is turned off.

5. The apparatus of claim 3, further comprising:
a magnet coupled to the rod, and
a sensor configured to detect a magnetic field from the magnet to determine a rotational position of the eccentric mass.

6. The apparatus of claim 1, further comprising a first plurality of percussive devices on the front panel of the torso covering, the eccentric masses of the first plurality of percussive devices synchronized to be simultaneously in the same angular orientation relative to the axis.

7. The apparatus of claim 1, further comprising a second plurality of percussive devices on the rear panel of the torso covering, the eccentric masses of the second plurality of percussive devices synchronized to be simultaneously in the same angular orientation relative to the axis.

8. The apparatus of claim 1, wherein the torso covering includes a vest.

9. The apparatus of claim 1, wherein the torso covering includes a wrap.

10. The apparatus of claim 1, further comprising a user interface releasably coupled to the torso covering and in communication with the plurality of percussive devices and configured to receive user input for adjusting percussive force of the plurality of percussive devices.

11. The apparatus of claim 10, wherein the user interface is releasably coupled to the front panel.

12. The apparatus of claim 1, wherein the front panel of the torso covering comprises a first section and a second section coupled to each other at a medial intersection.

13. The apparatus of claim 12, wherein the first and second sections are releasably coupled at the medial intersection by a zipper assembly having first and second zipper portions attached to the first and second sections, respectively.

14. The apparatus of claim 13, wherein the first and second zipper portions each having a top end and bottom end and are each angled between its respective top and bottom ends within the range of about 1 to about 5 degrees from the sagittal plane in opposite lateral directions.

15. The apparatus of claim 1, further comprising a power source releasably coupled to the torso covering.

16. The apparatus of claim 1, further comprising a break button for pausing a percussion cycle of the plurality of percussive devices.

17. The apparatus of claim 1, further comprising a power port coupled to the torso covering.

18. The apparatus of claim 1, wherein at least one of the front panel and the rear panel includes an inner pane, an outer pane, and a frame pane disposed between the inner and outer panes.

19. The apparatus of claim 18, wherein the inner and outer pane comprise compression foam and the frame pane comprises a semi-rigid plastic.
